(19) United States
(12) Patent Application Publication
(10) Pub. No.: US 2015/0103542 A1
(43) Pub. Date: Apr. 16, 2015

(54) Telescopic, Horizontally Rotatable Trouble Light Holder

(71) Applicant: Vincent James Brooks, Claresholm (CA)

(72) Inventor: Vincent James Brooks, Claresholm (CA)

(21) Appl. No.: 14/055,843

(22) Filed: Oct. 16, 2013

(51) Int. Cl. F21S 8/02

(52) U.S. Cl. CPC F21S 8/028
USPC 362/396; 362/430

(57) ABSTRACT

A trouble light holder for mounting under a vertically positioned cabinet having a flat bottom surface, to provide illumination for the area extending out from under the cabinet. The trouble light holder may include a mounting base plate, a telescopic, horizontally rotatable cantilever arm mounted to the base plate, a holder for a trouble light on the end of the telescopic arm, the holder being able to swivel or rotate horizontally, and a spring-loaded clip for the holder being held by a detent member. Thus the trouble light holder may allow light from a trouble light to be shined toward particular areas or objects on or around a work bench, and shined in various directions and angles, and this without shining light directly into a handyman's eyes. When not in use, the device may easily and quickly contract into a minimized storage position.

### BACKGROUND OF THE PRIOR ART

Humans need to gather sufficient light to effectively perform manual tasks. There is a particular need for adequate lighting in a handyman's work space, such as work benches, which are specifically designated areas for the performance of sometimes intricate manual tasks. Such work spaces are frequently located in garages and basements, however, and are therefore often dimly lit. Moreover, the work benches of such work spaces are often placed against a room's walls, which are often the furthest locations from the sources of light in a room.

Normally, such light sources are pre-installed light fixtures found in a room's ceiling, usually in the center of the room. The distance from a source of light in the center of the room to a work bench against one of the room's walls may result in decreased intensity of light, which may make it difficult for a handyman to reliably and quickly discern objects and details on the work bench. Moreover, since a handyman is often positioned at least partially in between the work benches and the light fixture, the silhouette of the handyman may often obstruct to some degree the source of light from shining directly on the work bench, thereby casting shadows over the work bench. In addition, various geometric objects in the room, including the cabinets and shelves that often hang over or near the work bench, may also cast shadows over the work bench.

Installing permanent light fixtures over or near the work space to provide additional light is not always possible or desirable, since such an installation normally requires running electrical wire though walls to reach a potentially remote part of a room. Suffice it to say that the costs and tedium involved with installing such permanent light fixtures over or around work benches often outweigh the benefits.

Even when such permanent light fixtures are installed closer to a work bench, cabinets and/or shelves and/or studs that may hang directly over or nearby the work bench, and/or other geometrical objects, may still cast shadows. Furthermore, even when such a light fixture is installed underneath such a cabinet, shelf, or stud, or on the wall next to the work bench, so that the light shines more directly onto the work bench, work benches are often large and cover more than just the limited area beneath such a light. Thus, the newly installed light may not adequately shine a sufficient amount of light on certain other areas of the work bench to allow the handyman to perform the desired manual tasks. In addition, such fixed lights may also shine directly into a handyman's eyes.

Fixed lights that are elongated tubes might run a greater portion of the length of a work bench but installation of such lights still involves the above-mentioned problems and disadvantages associated with installing fixed lights generally. Moreover, said long tube lights and the housing thereof may be bulky and take up substantial space in order to provide sufficient light for the entire length of the work bench. Such lights furthermore simultaneously provide light for much of the length of the bench rather than for just those particular areas that the handyman may be primarily concerned with. In addition, as with fixed lights generally, such tube lights may either shine light directly into the handyman's eyes or may cast shadows over the work bench due to the handyman's silhouette or other objects.

The problems associated with fixed lighting sources have resulted in a variety of alternative, semi-portable lighting systems, such as lamps, trouble lights, etc. Specifically as it relates to attempts to provide adequate light for a work space, such often-portable lighting systems share many of the same disadvantages as fixed lights. For example, it is difficult to position such portable lights to not cast shadows over the work space, without shining light into a handyman's eyes, and also difficult to quickly and easily position the light source to shine light directly on one particular area of a work space and then reposition the light source to shine directly on another separate area of the work space.

These difficulties arise partly from the fact that lamps usually have bases designed to lie on the ground, and thus must be positioned away from the work bench. In order to prevent the light from such lamps from shining directly into a handyman's eyes, such lamps are often placed behind the handyman, which usually casts shadows from the silhouette of the handyman and other objects. Such lamp bases, moreover, take up floor space and often incorporate tripod and other designs that are not sufficiently sturdy to remain intact after inadvertently coming into contact with other objects or persons. Desk lamps, furthermore, have bases that take up space on a work bench and often leave electrical cords loosely lying on the work bench.

Although certain specialized lamps or other lighting devices may allow adjusting to obtain certain desired positions for shining light—for example, by incorporating a movable arm (or more than one arm)—the position of the light source is normally limited to an area not less than the length of that arm, unless the entire lamp or lighting device (including the base) is moved.

In addition, many such lamps, as well as prior art light holders, are not able to be stored compactly when not in use. Some such lamps do have telescopic members designed to allow the total size of the lamp to be minimized, but these generally compact primarily along the vertical axes. Furthermore, any prior art lighting device that may have a member that retracts and extends along a horizontal axis to allow light to shine directly on objects on a work bench located away from the base of the lamp is unlikely to allow a handyman's eyes to be shielded from direct light emanating from the light source.

Rather than using lamps or certain other lighting devices in areas that do not receive adequate illumination from fixed lighting, many handymen often use and attempt to use trouble lights in work spaces. However, it is not easy to quickly position such trouble lights so that they shine light on a particular area of a work bench where illumination is desired at a given moment, and then on another work bench area in another moment. Even when a desired trouble light position is achieved, the trouble light might be unstable so that even the inadvertent bump might change the direction of the light. Furthermore, resting such trouble lights on a work bench takes up valuable space and potentially leaves electrical wire or cord free and exposed on the work bench. On the other hand, hanging such lights on hooks in a wall may either shine light into the handyman's eyes and/or also cast shadows on the work space.

Some prior art trouble light holders not may secure trouble lights in a sufficiently stable position while still allowing adjustment in order to shine light in a particular area or areas of a work bench. In part this may be due to the difficulties of grabbing conical objects like trouble lights. Even when a trouble light holder may securely grab a trouble light, furthermore, the holder may not allow the trouble light to radially spin to further direct the light, while staying in a secure position. Moreover, although some devices may utilize clamp-like features to attach a light source such as a trouble light to a particular surface or object, few devices utilize a clamping mechanism to actually securely hold and release a trouble light, which may then be positioned and repositioned in various coordinates of a horizontal plane to provide adequate illumination to the work space. Furthermore, no prior art device attempts to accomplish all this while mounted under a vertically positioned object having a flat bottom surface, thus freeing up space on the work bench.

### SUMMARY OF INVENTION

A trouble light holder for providing adequate illumination to a countertop work area that is vertically spaced below an upper cabinet, shelf, or stud mount and extends outwardly an extended-countertop width beyond a given width of the upper cabinet. The trouble light holder has a base plate mounted to a horizontally-oriented bottom surface of the cabinet, and a cantilever arm that extends from the base plate horizontally outwardly beyond the width of the cabinet to a light holder end thereof. This enables a trouble light to be positioned outwardly over extended countertop width of the work area beyond the width of the cabinet, and at a maximum height above the countertop work area from the bottom surface of the cabinet. The position of the trouble light over the extended countertop width of the work area may be adjusted through horizontal rotation of a light-holder end of the cantilevered arm, horizontal angle of rotation of the light holder, telescoping movement of a telescoping section of the cantilevered arm, as well as radial rotation of the trouble light. This enables a wide range of positions so that the light from the trouble light may provide illumination on particular objects in or areas of a work space, without the light shining directly into the eyes of the handyman. By mounting to the underside bottom surface of the cabinet, shelf, or stud mount, the trouble light holder is kept out of the way and leaves more workspace available on the countertop work area.

In one embodiment, horizontal rotation of the trouble light over the countertop work area may be accomplished by connecting the pivoting cantilevered arm to the base by placing a bolt through a hole in the arm a distance (which in one embodiment may be just a few inches) from the end of the arm, and through a hole in the base, and then securing the bolt with a nut on the opposite side of the base. A portion of the arm may be left on the opposite side of the bolt in order to assist in supporting the weight from the rest of the arm and light holder by applying pressure against the base. A means for decreasing the coefficient of friction between the portion of the arm on the opposite side of the bolt and the base, such as for example (but not limited to) a felt pad, may allow the arm to more freely rotate horizontally.

The horizontally rotatable cantilever arm, furthermore, may itself be telescopic or have a telescopic extension, thus allowing the light source at the opposite end of the arm to be positioned at greater distance from the base plate and at a point less than the length of the fully extended arm. The telescopic cantilever arm may be comprised or two (or more) separate members, where one member extends and retracts into another member. In one embodiment, this could be accomplished through a full extension drawer slide turned on its side, or, in another embodiment, through a sliding track system. A stopping means might also be incorporated into the arm to prevent the two members from separating from one another entirely.

There may also be a means along the arm for securing electrical wire or a cord so that it does not dangle over, or take up space on, the work bench. To this end, certain embodiments may use sets of dowels located along the telescopic cantilever arm, shaped and positioned to hold an electrical cord. In one embodiment, the telescopic cantilever arm could contain three sets of three dowels with the center dowel of the each set being offset to apply pressure on a cord placed therein. In an embodiment, each dowel may also have grooves for keeping the cord secure, while avoiding excessive bending that might otherwise damage the cord

The light holder at the end of the arm may swivel or rotate horizontally 360 degrees. One side of the light holder may have housing to obstruct light on that end from shining directly into a handyman's eyes, or such housing may be part of the trouble light itself. In one embodiment, the horizontally rotating movement may be accomplished by drilling a hole at the end of the arm that is not connected to the base, and then attaching the light holder component to the arm using a bolt. In one embodiment, said hole may be a cavity drilled only partially through the bottom of the arm, leaving the top of arm intact, and securing a lock nut in the hole. The bolt attached to the light holder component may then be connected to the lock nut.

The light holder component may grab and release a conical object, such as a trouble light, or even a flashlight. In one embodiment, the light holder component may be clamp-like, and the grabbing and releasing may be accomplished by a clamp having basically u-shaped cross-sections. Said clamp, in one embodiment, may also have a hook shape or a three-fingered “claw” design. One of the fingers of the claw, or one part of the hook design, may have a spring-loaded mechanism for applying pressure to the perimeter of a conical object. Thus the trouble light may be easily removed from the claw/clamp/hook of the trouble light holder and used elsewhere according to the preference of the artisan. The clamp-like holder may also have a means for more easily manually opening the holder to receive the trouble light, such as a piece with a sufficient cross-sectional area for allowing a finger or fingers to apply force opposing the forces of the spring-loaded mechanism. The clamp-like, spring-loaded holder may also have a piece or pieces to prevent the force of the spring-loaded mechanism from causing pieces of the holder to separate entirely.

The bolt connecting the light holder to the arm, in one embodiment, may be of such dimensions as to prevent interference with the spring action on the clamp, and also to avoid excess pressure on the inside of the nut (for the embodiment incorporating such a nut), which pressure could potentially damage top of the arm. The light holder may also be designed to allow easy access to an on/off switch of the trouble light. The trouble light may also rotate radially (essentially spinning in place while secured in the holder) while being held by the clamp.

Due to the telescopic arm and horizontal rotation capability, the position of the light source may also extend beyond the work bench and provide illumination to other areas of work space, which could be helpful for finding items in drawers, cabinets, or toolboxes, or, when the telescopic cantilever arm is at an angle perpendicular with the length of the work bench, may even allow the light to shine over the engine of a nearby automobile. One embodiment may have a telescopic cantilever arm length of about 48 inches when in a fully extended position, and roughly 28 inches when in a compacted position, which when mounted at the center of an 8-foot work bench, may allow the trouble light to be positioned up to or over the edge of the work bench. Other embodiments may include telescopic cantilever arms of varying lengths, such as one embodiment that is 58-60 inches in the fully extended position, thereby providing adequate light for many coordinates in a work space containing a 10-foot work bench.

When the telescopic arm is in a contracted position, the device may easily and quickly be stored in a compact position where it is mounted, thus keeping the workspace area more clear.

The above description and listed alternative embodiments are considered that of some embodiments only. It is understood that the embodiments shown in the drawings and described above are merely for illustrative purposes and not intended to limit scope. Alterations and modifications of the trouble light holder, and such further applications of the principles of the trouble light holder as disclosed herein, are contemplated as would occur to those skilled in the arts to which the article pertains. For example, it is anticipated that the size of the arm, clamp, and base may vary according to size of the work space and intended use. It is further anticipated that the light holder component may be used to hold other types of light sources shaped as conical objects such as flashlights.

### BRIEF DESCRIPTION OF THE DRAWINGS

FIG. 1 is a front overhead perspective view of a telescopic, horizontally rotatable trouble light holder in its environment of use, with a base plate of the trouble light holder mounted to an underside of a cabinet hanging over a work bench.

FIG. 2 is a top perspective view of the trouble light holder of FIG. 1, having a telescopic cantilever arm, and a clamp-like holder holding a trouble light.

FIG. 3 is a bottom perspective view of the base plate of FIG. 1, attached to a cantilever arm portion of the telescopic cantilever arm of FIG. 2.

FIG. 4 is a top perspective view of the base plate of FIG. 1, attached to the cantilever arm portion of the telescopic cantilever arm of FIG. 2.

FIG. 5 is a top perspective view of a telescoping extension portion of the telescopic cantilever arm of FIG. 2.

FIG. 6 is a top perspective view of the clamp-like holder of FIG. 2, holding a trouble light.

FIG. 7 is a bottom perspective view of two detached pieces of the clamp-like holder of FIG. 6.

FIG. 8 is a bottom perspective view of the two pieces of the clamp-like holder of FIG. 6, attached by springs.

FIG. 9 is a top perspective view of the two pieces of the clamp-like holder of FIG. 6, detached.

FIG. 10 is a top perspective view of the two pieces of FIG. 8, attached.

FIG. 11 is a top perspective view of the trouble light holder of FIG. 1, with the telescoping extension portion of the cantilever arm in the extended position, and a close up view of a means for securing a cord to the trouble light holder of FIG. 1.

### DETAILED DESCRIPTION

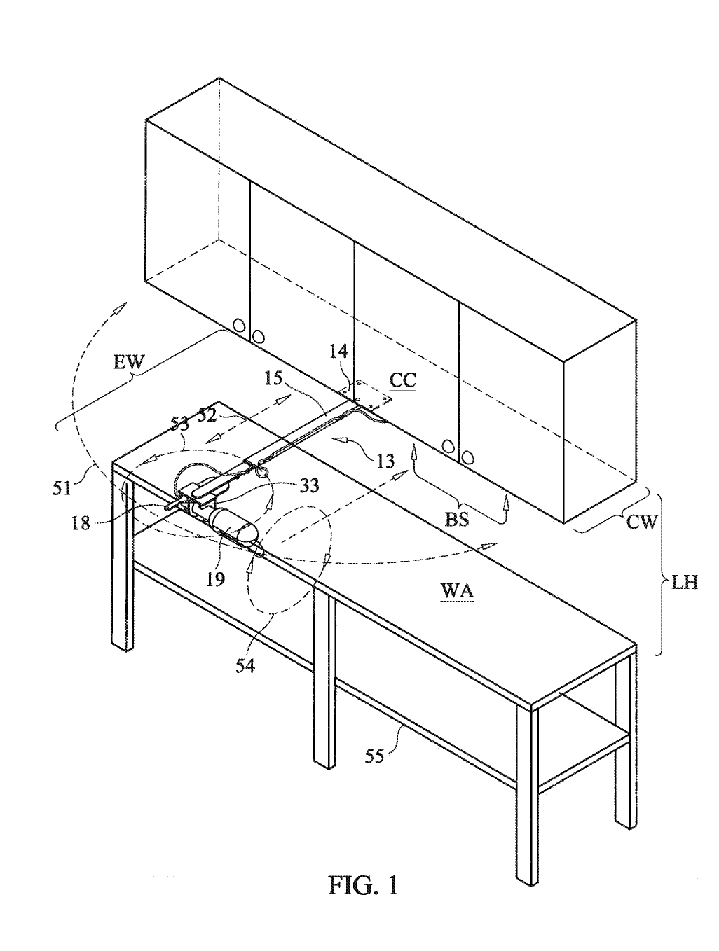

Referring to the drawings, FIG. 1 illustrates a trouble light holder 13 in accordance with the present invention for providing adequate illumination to a countertop work area WA that is vertically spaced below an upper cabinet, shelf, or stud mount, designated CC, and extends outwardly an extended countertop width EW beyond a given width CW of the upper cabinet. The holder includes a base plate 14 for mounting to a horizontally-oriented bottom surface BS of the cabinet, and a telescopic cantilever arm 15 that extends from the base plate 14 horizontally outwardly beyond the width CW of the cabinet to a light holder end 18 thereof. This enables a trouble light 19 to be positioned outwardly over extended countertop width EW of the work area WA beyond the width CW of the cabinet, and at a maximum height LH above the countertop work area WA from the bottom surface BS of the cabinet.

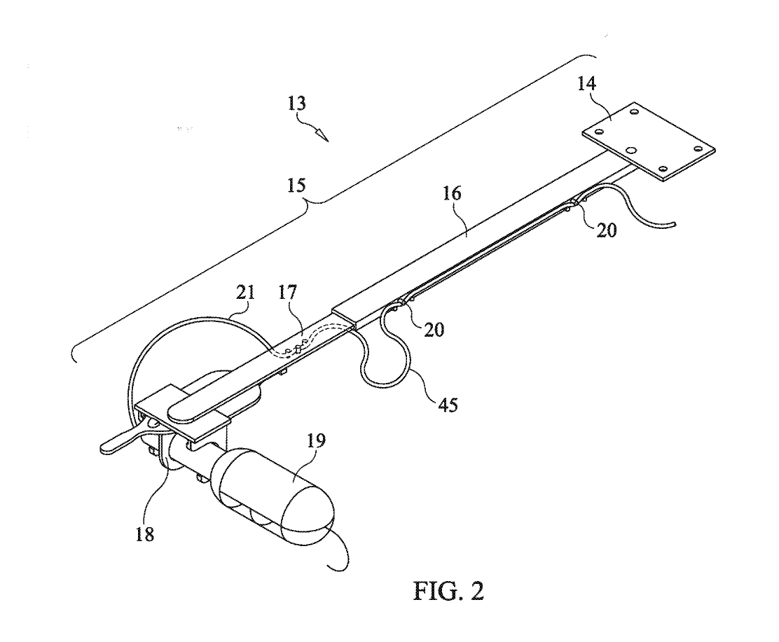

In the preferred embodiment illustrated in FIG. 2, the mountable, rotatable, telescopic trouble light holder 13 is comprised of the mountable base plate 14, a telescopic cantilever arm 15 that may rotate horizontally with respect to the base plate 14, a horizontally rotatable device for holding or securing 18 (also referred to herein as a light holder end) a conical object such as a trouble light 19, and a means for securing 20 a cord or wire 21. The telescopic cantilever arm 15 may be comprised of a cantilever arm 16 secured to the base 14 and a telescopic extension 17.

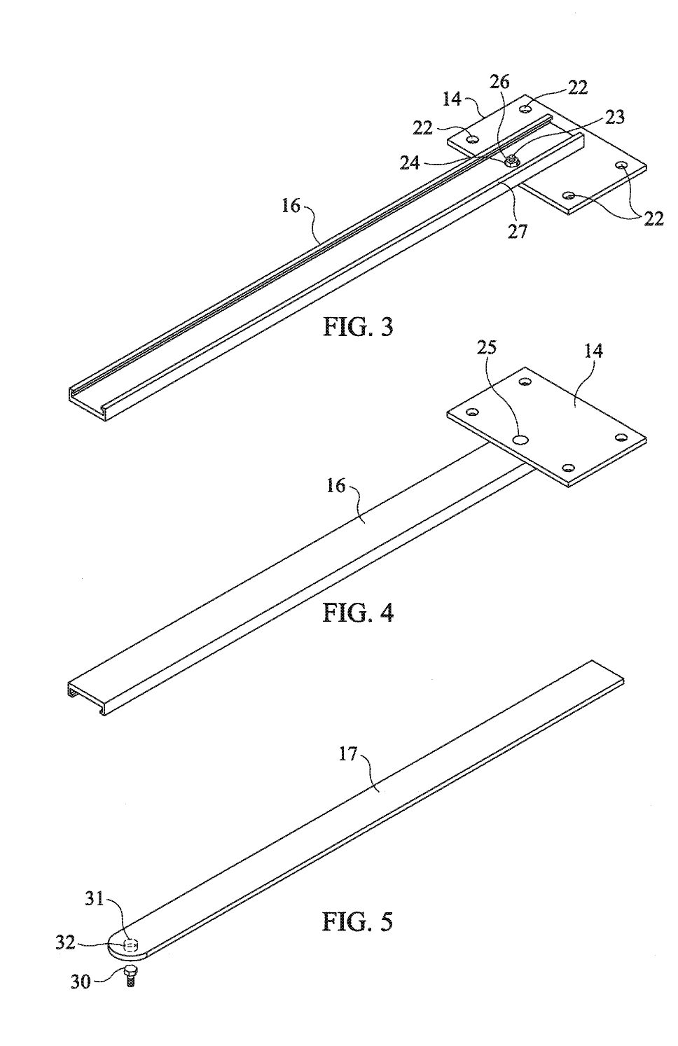

As shown in FIGS. 3 and 4, the base plate 14 may have a means for mounting to a surface 22. The cantilever arm 16 may be secured to the base plate 14, in one embodiment, by placing a bolt 23 through a hole 24 in the cantilever arm 16 and a hole 25 in the base plate 14, and, and then securing the bolt 23 with a nut 26, in such a manner that horizontal rotation is permitted. In one embodiment, the hole 24 in the first member 16 may be a short distance from the end of the cantilever arm 16, leaving a portion 27 of the cantilever arm 16 on the opposite side of the bolt 23 in order to assist in supporting the weight from the rest of the telescopic cantilever arm 15 and the trouble light holder 18 (FIG. 2). As shown in FIG. 5, the telescopic extension 17, in the embodiment described herein, may be of such a shape as to allow it to extend and retract from the cantilever arm 16, in a manner shown in FIG. 2.

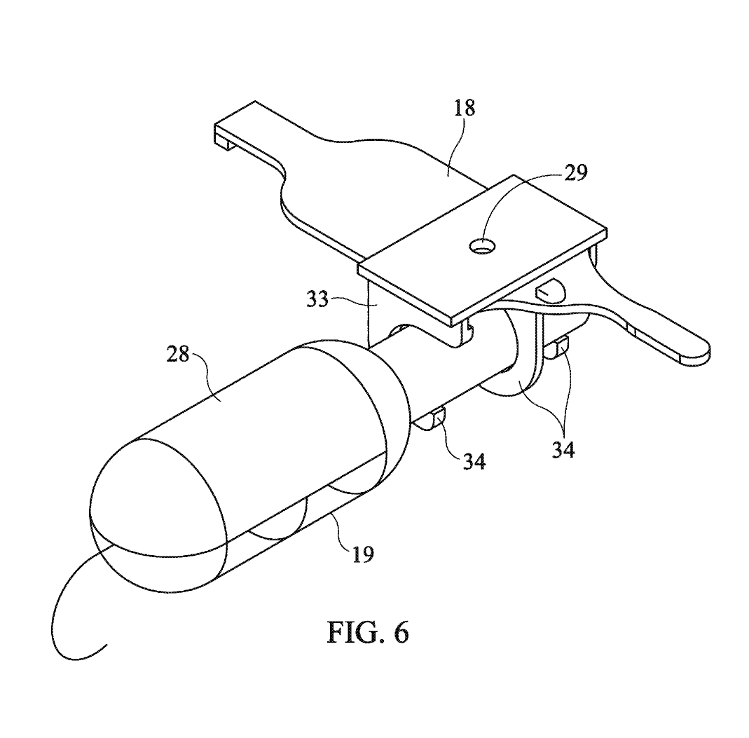

The telescopic cantilever arm 15, as shown in FIG. 2, may be attached to the horizontally rotatable device for holding or securing 18 a conical object such as a trouble light 19. As shown in FIG. 6, this trouble light 19 or trouble light holder 18, may have housing 28 to obstruct light from directly emanating from the trouble light 19 on that side where the housing 28 is located.

The top of the trouble light holder 18 may have a means for securing 29 to the telescopic cantilever arm 15 or, in the embodiment described herein, to the telescoping extension 17 of the telescopic cantilever arm 15 (as shown in FIG. 2). For example and in greater detail, the trouble light holder 18 may be attached to the telescopic cantilever arm 15 by drilling a hole 29 in the top of the trouble light holder 18 (FIG. 6), wherein a bolt 30 may be fastened (FIG. 5). Then (in the particular embodiment described herein) another hole or a cavity 31 may be partially drilled through the bottom of telescoping extension 17, leaving the applicable top portion of the telescopic cantilever arm 15 intact, with a lock nut 32 being secured in the hole or cavity 31, to which the bolt 30 that may be fastened to the trouble light holder 18 may be connected.

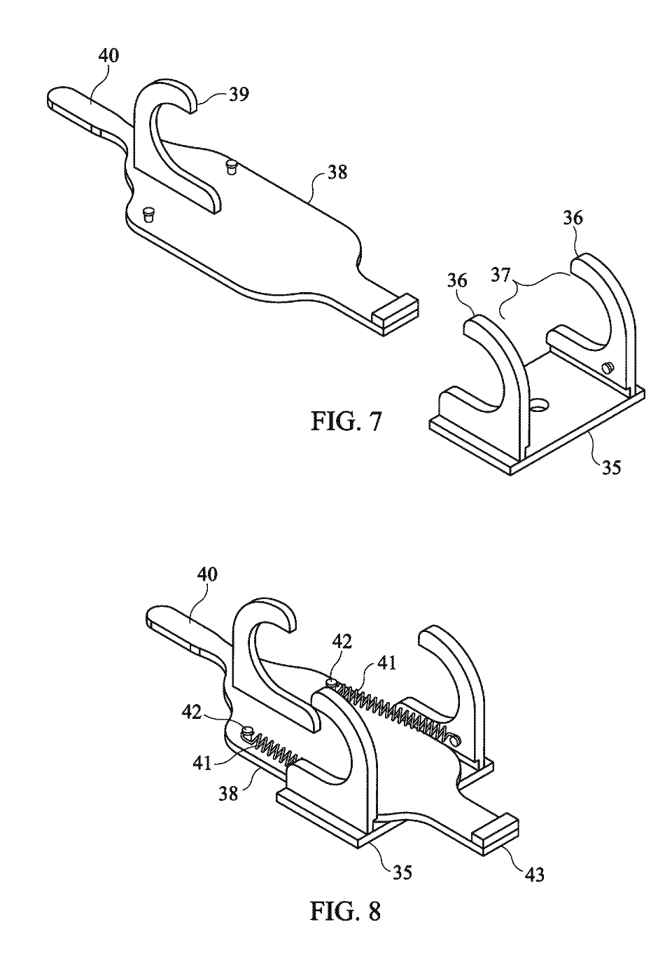

As also shown in FIG. 6, the trouble light holder 18 may secure and release a trouble light 19. This may be accomplished, in the embodiment described herein, by a clamp-like holder 33 with basically u-shaped cross-sections, or a component having a “claw” or hook design 34. As shown in FIG. 7, such a component might have a three-fingered claw design being comprised of two main pieces, a first piece 35 having at least two u-shaped or hook-shaped “fingers” 36, with the two fingers separated by some space 37 and facing the same direction, and a second piece 38 with at least one finger 39, where said finger 39 may face the opposite direction as the two fingers 36 and may be aligned to fit in the space between the two fingers 37. The second piece 38 may have a handle-shaped end 40, to facilitate horizontally rotation or swiveling by manual means.

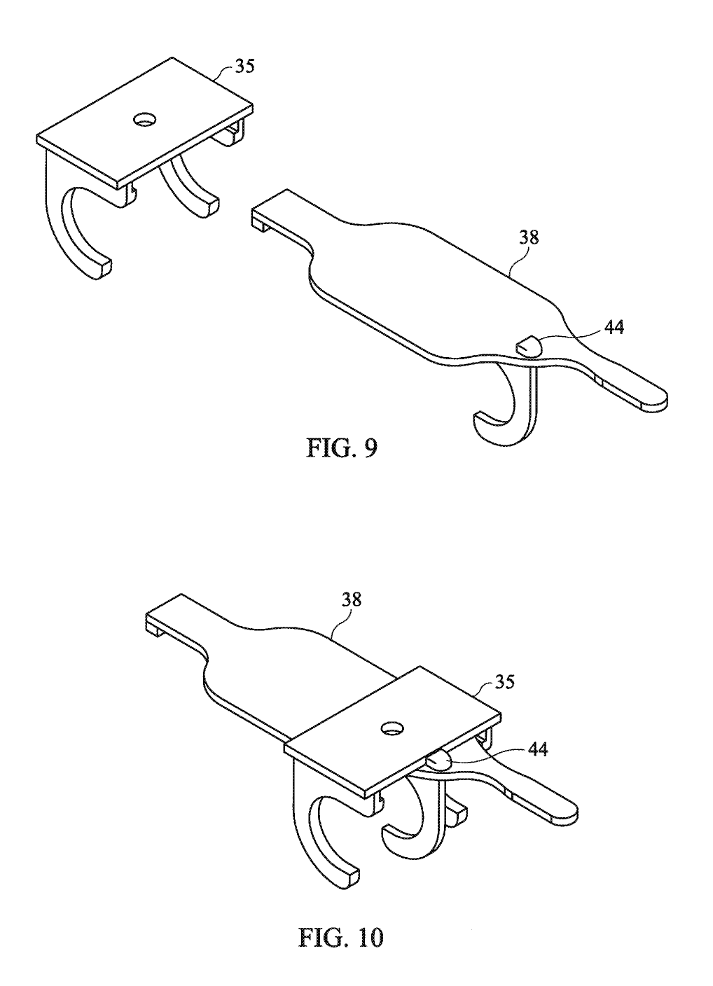

As shown in FIG. 8, the first piece 35 and the second piece 38 may be attached to one another by springs 41 fastened by screws 42, thereby creating a spring loading action. On the second piece 38, on the end on the opposite side from the handle-shaped end 40, there may also be larger cross-sectional area 43, which may provide a larger area to assist fingers in applying a force in the horizontal direction (that is, applying pressure in the direction from the larger cross-sectional area 43 towards the handle-shaped end 40) which force might oppose the force of the spring-loaded mechanism created by the springs 41, opening the clamp-like holder 33 (FIG. 6) to receive a trouble light 19.

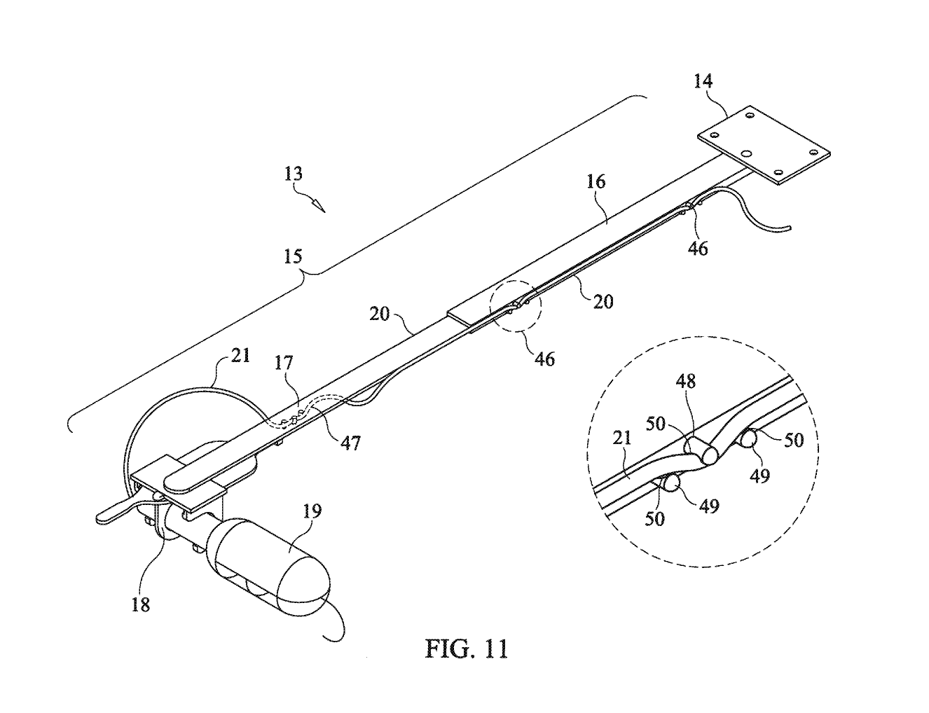

FIG. 9 is a top perspective view of two detached pieces of the clamp 35, 38, illustrating how they may be aligned, and also showing a stopper piece 44 that, as shown in FIG. 10, may obstruct the first piece 35 from continuing in the natural path due to the spring-loaded mechanism, thereby preventing the two pieces 35, 38 from separating.

When the clamp 36 is assembled (FIG. 6), and the trouble light holder 18 is attached to the telescopic cantilever arm 15, as shown in FIGS. 21 and 11, the position of the trouble light 19 may extend out from the base plate 14. Some slack in the cord 45 (FIG. 2), may allow the telescopic cantilever arm 15 to reach an extended position, as shown in FIG. 11. The cord 21, furthermore (even when in the retracted position of FIG. 2 where the cord has some slack 45) may be kept from dangling loosely from the telescopic cantilever arm 15 by means for securing the cord 20, which in the embodiment described herein may be three sets of dowels 20, with two sets 46 being along the side of the cantilever arm 16, and a third set 47 being along the underside of the telescoping extension 17, in such a manner as to not obstruct the telescoping extension 17 from retracting into the cantilever arm 16.

As shown in the close-up figure of FIG. 11, in the embodiment described herein, each set of dowels 20 may consist of three dowels, with the center dowel 48 slightly offset from the other two 49. In addition, on the bottom side of the center dowel 48 facing the other two dowels 49, and on the top side of the two outside dowels 49 facing the center dowel 48 there may be in each dowel 48, 49 a semi-circular shaped groove 50, of a size for holding a cord 21. In this manner, the cord 21 may be secured while avoiding the potentially destructive forces caused by excessive bending of the cord 21 (at, for example, too sharp of angles).

As illustrated in FIG. 1, the base plate 14 of the assembled mountable, horizontally rotatable, telescopic trouble light holder 13 may mount to any flat bottom surface, such as the horizontally-oriented bottom surface BS of an upper cabinet, shelf, or stud mount CC, not only maximizing available space of the countertop work area WA, but also making the direct light from the trouble light 19 more easily available in areas and at angles hitherto uncommon in the prior art of trouble light holders. First, with respect to the base plate 14 the telescopic cantilever arm 15 may horizontally rotate in a roughly 180 degree arc 51. The circumference of this arc 51 may vary depending on the length of the telescopic cantilever arm 15 (the radius or extended countertop width EW), which as mentioned may retract or extend in a forward and backward motion 52. In addition, the trouble light holder 18 at the end of the telescopic cantilever arm 15 may swivel or rotate 360 degrees, also along a horizontal axis 53. The trouble light 19 itself may also rotate radially, 360 degrees, along a vertical axis 54 while being held by the clamp-like holder 33. In this manner, with four separate axes of motion 51, 52, 53, 54 adequate light may be provided for many coordinates within a countertop work area WA, and in other areas beyond a work bench 55, and this while providing more available space to a countertop work area WA, and while allowing the trouble light 19 to be positioned so that its direct light does not shine into a handyman's eyes.

I claim:

1. A trouble light holder for mounting from a bottom surface of an upper cabinet, shelf, or stud mount that is vertically spaced over a countertop work area extending an extended countertop width beyond a given width of the cabinet, shelf, or stud mount, comprising:
a base plate for mounting to the bottom surface of the upper cabinet, shelf, or stud mount;
a telescopic cantilever arm mounted to the base plate and having a light-holder end extending over the countertop work area beyond the given width of the cabinet, shelf, or stud mount;
the light-holder end of the telescopic cantilever arm connected to the base plate being horizontally rotatable over the countertop work area;
the light holder end of the telescopic cantilever arm being horizontally rotatable;
whereby said trouble light holder for mounting to the bottom surface of the upper cabinet, shelf or stud mount enables a trouble light to be held in a wide range of adjustable positions for maximum illumination of the countertop work area extending beyond the given width of the upper cabinet, shelf or stud mount, and to be removed therefrom to allow manual positioning by the user.

2. The trouble light holder of claim 1, where the telescopic cantilever arm consists of a cantilever arm and a telescoping extension.

3. The trouble light holder of claim 1, where the light holder end is clamp-like and has a spring-loaded clip held by a detent member.

4. The trouble light holder of claim 3, where the clamp-like light holder has a hook-shaped design.

5. The trouble light holder of claim 4, where the hook-shaped clamp-like light holder has three fingers, with one middle finger facing the opposite direction as the other two fingers.

6. The trouble light holder of claim 1, where the telescopic cantilever arm is configured as a flat track (for lying flat against the cabinet bottom surface).

7. The trouble light holder of claim 1, where the length of the telescopic cantilever arm may be placed at such an angle with respect to the base plate as to be kept within or extend just beyond the cabinet width to keep a trouble light out of the way when stowed.

8. The trouble light holder of claim 1, where a telescoping section of the telescopic cantilever arm has a length to extend over the typical extension width of a typical countertop work area.

9. The trouble light holder of claim 1, where the plane of rotation of the holder is arranged in parallel over the extension width of the typical countertop work area.

10. The trouble light holder of claim 3, where the clamp-like light holder capable of horizontal rotation may swivel 360 degrees.

11. The trouble light holder of claim 1, where the telescopic cantilever arm has means for securing a cord.

12. The trouble light holder of claim 11, where said means for securing a cord are sets of dowels.

13. The trouble light holder of claim 12, where each set of dowels is made of three dowels, with the middle dowel of each set offset from the other two dowels.

14. The trouble light holder of claim 12, where one or more dowels have a groove of a size for receiving a wire or cord to prevent excessive bending of the wire or cord.

15. The trouble light holder of claim 11, where said means for securing electrical wire or a cord consist of hooks.

16. The trouble light holder of claim 1, where the telescoping movement of the telescopic cantilever arm is accomplished by a track system.

17. The trouble light holder of claim 1, where the telescoping movement of the telescopic cantilever arm is accomplished by a full extension drawer slide turned on its side.

18. The trouble light holder of claim 3, where the clamp-like holder clamps the trouble light firmly enough to secure the trouble light, yet has a sufficiently low coefficient of friction to allow the trouble light to radially spin while secured in the holder.

19. The trouble light holder of claim 1, where a material with a low coefficient of friction is between the cantilever arm and the base plate.

20. The trouble light holder of claim 3, where the clamp-like light holder has u-shaped cross sections.
